(19) United States
(12) Patent Application Publication
(10) Pub. No.: US 2018/0048215 A1
(43) Pub. Date: Feb. 15, 2018

(54) DEVICE AND METHOD FOR LIQUID COOLING OF AN ELECTRIC MOTOR

(71) Applicant: BAE Systems Hägglunds Aktiebolag, Örnsköldsvik (SE)

(72) Inventor: Viktor LASSILA, Arnäsvall (SE)

(73) Assignee: BAE Systems Hägglunds Aktiebolag, Örnsköldsvik (SE)

(21) Appl. No.: 15/559,740

(22) PCT Filed: Mar. 24, 2016
(86) PCT No.: PCT/SE2016/050254

§ 371 Date: Sep. 19, 2017

(30) Foreign Application Priority Data
Apr. 2, 2015 (SE) 1550409-5

(51) Int. Cl. H02K 9/19; H02K 5/20

(52) U.S. Cl. CPC H02K 9/19; H02K 5/20; H02K 2209/00

(57) ABSTRACT

A device for liquid cooling an electric motor having a rotor and a stator includes at least one cooling liquid applicator arranged to apply cooling liquid onto the stator. The cooling liquid applicator is moveably arranged relative to the stator so that the cooling liquid by means of movement of the cooling liquid applicator is applied onto different areas of the stator. A method for liquid cooling an electric motor and a platform that includes the device are also described.

### TECHNICAL FIELD

The present invention relates to a device for liquid cooling of an electric motor according to the preamble of claim 1. The present invention also relates to a method for liquid cooling of an electric motor. The present invention also relates to a motor vehicle.

### BACKGROUND

During operation electric motors are heated whereby cooling is required to divert the heat. Cooling of electric motors can be performed using different types of cooling medium such as for example air, water or oil.

In high performance electric motors cooling is extremely important in order to maintain performance. Cooling of active parts of the electric motor directly affects the performance. Hereby, liquid cooling using for example oil lead to effective cooling.

An important motor component having a large need for cooling is the stator of the electric motor and in particular the end portions of the stator encompassing the coil ends of the stator winding. For this reason many cooling devices are configured to apply a cooling medium onto the end portions of the stator and the thereby often exposed coil ends.

The stator winding often comprises a coated isolated conductor and a known problem of cooling devices wherein a liquid cooling medium is flushed directly onto the coil ends is erosion. The often statically applied stream of cooling liquid erodes the coating of the stator winding within the application surface which eventually risks damaging the motor.

This problem is generally solved by applying the cooling liquid in the form of a spray (aerosol particles) that is sprayed onto the stator winding and in particular its coil ends by the end portions of the stator instead of applying the cooling liquid in the form of a substantially flowing stream that strikes the same surface of the stator winding.

Such a solution is for example described by U.S. Pat. No. 2,648,085 wherein a cooling medium is sprayed onto the stator winding.

A problem with spray cooling is that a certain flow is required in order to generate the spraying/mist. If the flow is insufficiently low the desired spraying will not be accomplished whereby the cooling will become unsatisfactory. Hereby the risk is that so called local hot spot will be created.

### OBJECTS OF THE INVENTION

An object of the present invention is to provide a device and a method for liquid cooling of an electric motor that solves or at least alleviates one or more of the above mentioned problems associated with known cooling devices.

A particular object of the invention is to provide a device and a method for liquid cooling of an electric motor that accomplishes simple and effective cooling of the electric motor.

### SUMMARY OF THE INVENTION

These and other objects, apparent from the following description, are achieved by a device and a method, of the type stated by way of introduction and which in addition exhibits the features recited in the characterising clause of the appended claims 1 and 9. Furthermore, the objects are achieved by a platform according to claim 14. Preferred embodiments of the device, method and platform are defined in appended dependent claims 2-8, 10-13 and 15.

According to the invention the objects are achieved by a device for liquid cooling of an electric motor having a rotor and a stator, comprising at least one cooling liquid applicator arranged to apply cooling liquid onto said stator, characterized by that said cooling liquid applicator is moveably arranged relative to said stator so that the cooling liquid is applied onto different areas of said stator by means of movements of the cooling liquid applicator.

By means of arranging said cooling liquid applicator so that it moves relative to the stator upon application of cooling liquid the cooling liquid can be applied in the form of one or more streams which by means of the movement of the cooling liquid applicator strikes different areas of the end portion of the stator, whereby the problems with erosion as mentioned above can be avoided or at least largely alleviated. Hereby consequently the problem arising from if the spraying functionality no longer works is solved with the result of a directed stream in that the liquid cooling applicator thus is moveably arranged. Hereby is enabled to use a cooling liquid applicator without spray functionality/spray nozzles since good distribution of cooling liquid is achieved by means of the movement of the cooling liquid applicator, but also a liquid cooling applicator with spray functionality/spray nozzles that upon functioning spraying functionality provides additional distribution of the cooling liquid apart from the distribution accomplished by means of the spraying and also upon non-functioning spray functionality by means of that the liquid cooling applicator enables continued good distribution of the cooling liquid. Consequently it is hereby enabled an effective and simple cooling of the electric motor.

According to an embodiment of the device said liquid cooling applicator comprises a nozzle for application of said cooling liquid and a holder for supporting said nozzle. Hereby is achieved to allow movement of the nozzle relative to the holder. Each respective cooling liquid applicator may comprise one or more nozzles. A nozzle may comprise one or more outlets for application of cooling liquid.

According to an embodiment of the device said nozzle is moveably arranged relative to said holder. Hereby is achieved an effective way of distributing the cooling liquid by means of the movement of the nozzle.

According to an embodiment of the device said nozzle comprises an eccentrically arranged outlet so that the nozzle is allowed to move relative to the holder by means of a force generated by the application of liquid. Hereby is provided an effective way to move the liquid cooling applicator by only using force from the application of liquid.

According to an embodiment of the device said holder is moveably arranged relative to said stator. Hereby is provided an alternative way of achieving movement of the liquid cooling applicator for effective distribution of the cooling liquid. The holder is according to a variant arranged moveably attached.

According to an embodiment of the device said movement of the liquid cooling applicator is arranged to be caused by means of a force generated by the application of liquid. Hereby is enabled automatic movement of the cooling liquid applicator by means of the force from the application of liquid and consequently effective and simple cooling of the electric motor is facilitated.

According to an embodiment of the device said cooling liquid applicator is supported by means of a housing accommodating the electric motor.

According to an embodiment of the device said cooling liquid applicator is supported by means of an end wall portion of said housing.

According to an embodiment of the device said cooling liquid applicator is supported by means of the rotor shaft of said rotor.

According to an embodiment of the device said cooling liquid applicator is arranged to apply cooling liquid onto at least an end portion of said stator. Hereby cooling liquid is applied onto a portion having the largest need for cooling.

According to the invention the objects are also achieved by a device for liquid cooling of an electric motor having a rotor and a stator, comprising the steps of: applying cooling liquid onto said stator by means of at least one liquid cooling applicator, characterized in that during application cooling liquid to cause said liquid cooling applicator to move relative to said stator so that the cooling liquid by means of the movement of the liquid cooling applicator is applied onto different area of said stator.

Hereby the cooling liquid can be applied in the form of one or more streams which due to the movement of the liquid cooling applicator strikes different areas of the end portion of the stator, whereby the problems with erosion as mentioned above can be avoided or at least largely alleviated. Hereby consequently the problem arising from if the spraying functionality no longer works is solved with the result of a directed stream in that the liquid cooling applicator thus is moveably arranged. Hereby is enabled to use a cooling liquid applicator without spray functionality/spray nozzles since good distribution of cooling liquid is achieved by means of the movement of the cooling liquid applicator, but also a liquid cooling applicator with spray functionality/spray nozzles that upon functioning spraying functionality provides additional distribution of the cooling liquid apart from the distribution accomplished by means of the spraying and also upon non-functioning spray functionality by means of that the liquid cooling applicator enables continued good distribution of the cooling liquid. Consequently it is hereby enabled an effective and simple cooling of the electric motor.

According to an embodiment the method comprises the step of applying said cooling liquid by means of a nozzle supported by a holder for said nozzle. Hereby is achieved to allow movement of the nozzle relative to the holder.

Each respective cooling liquid applicator may comprise one or more nozzles. A nozzle may comprise one or more outlets for application of cooling liquid.

According to an embodiment the method comprises the step of applying liquid by means of said nozzle for causing a movement of the nozzle relative to said holder. Hereby is achieved an effective way of distributing the cooling liquid by means of the movement of the nozzle.

According to an embodiment of the method the step of applying liquid is performed using an eccentrically arranged outlet of the nozzle so that the nozzle is allowed to move relative to the holder by means of a force generated by the application of liquid. Hereby is provided an effective way to move the liquid cooling applicator by only using force from the application of liquid.

According to an embodiment of the method the step of applying cooling liquid comprises causing said holder to move relative to said stator during application of the cooling liquid. Hereby is provided an alternative way of achieving movement of the liquid cooling applicator for effective distribution of the cooling liquid. The holder is according to a variant arranged moveably attached.

According to an embodiment the method comprises the step of generation of a force caused by application of the cooling liquid so as to provide said movement of the cooling liquid applicator. Hereby is enabled automatic movement of the cooling liquid applicator by means of the force from the application of liquid and consequently effective and simple cooling of the electric motor is facilitated.

According to an embodiment of the method the step of applying cooling liquid onto said stator comprises applying cooling liquid onto at least an end portion of said stator. Hereby cooling liquid is applied onto a portion having the largest need for cooling

### DESCRIPTION OF THE DRAWINGS

A better understanding of the present invention will be had upon the reference to the following detailed description when read in conjunction with the accompanying drawings, wherein like reference characters refer to like parts throughout the several views, and in which:

FIG. 1 schematically illustrates a platform according to an embodiment of the present invention;

FIG. 2 schematically illustrates a cross section view of an electric motor comprising a device for liquid cooling of the electric motor according to an embodiment of the present invention;

FIG. 3a schematically illustrates a cooling liquid applicator according to an embodiment of the present invention;

FIG. 3b schematically illustrates a cooling liquid applicator according to an embodiment of the present invention;

FIG. 3c schematically illustrates a cooling liquid applicator according to an embodiment of the present invention;

FIG. 4 schematically illustrates a flow diagram of a method for liquid cooling of an electric motor according to an embodiment of the present invention.

### DESCRIPTION OF EMBODIMENTS

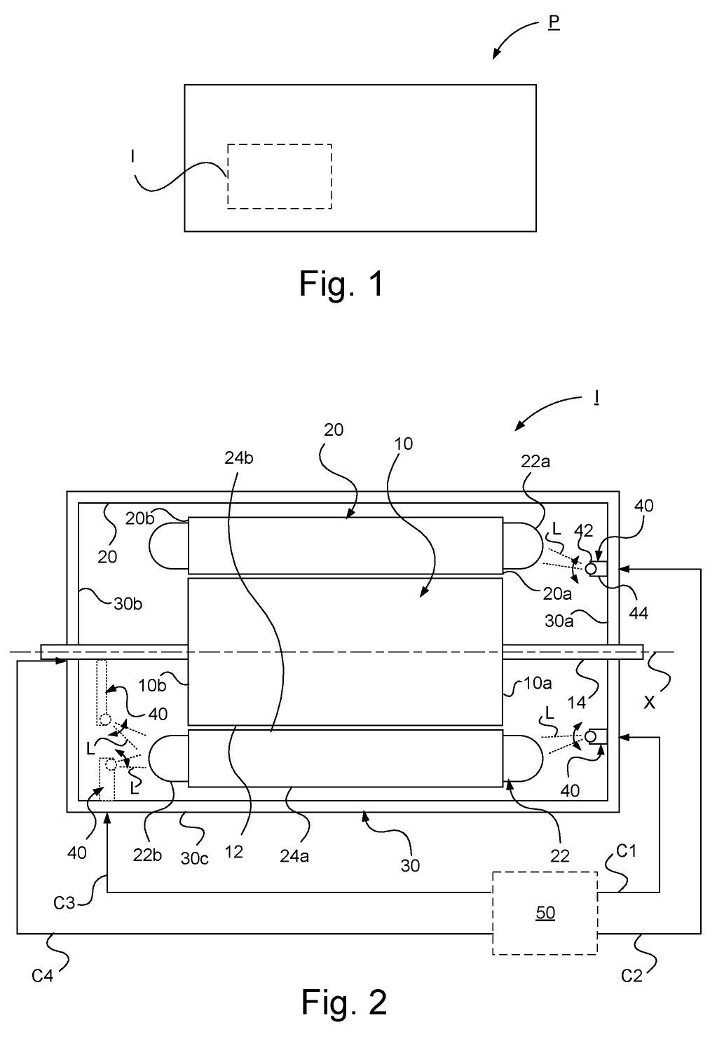

With reference to FIG. 1 a platform P is shown, wherein the platform P is comprised in a group comprising motor vehicles such as military vehicles, utility vehicles, automobiles, boat, helicopter or similar, a power station, any electrically driven machine or similar device wherein the device comprises an electric motor for operation thereof. The platform P comprises at least one electric motor 1 comprising a device I for liquid cooling of the electric motor 1 according to the present invention.

According to an embodiment in which the electric motor is comprised in a motor vehicle the electric motor is configured for propulsion of said motor vehicle, which thereby comprises an electrically driven motor vehicle. The device I for liquid cooling may be configured according to any of the below described embodiments.

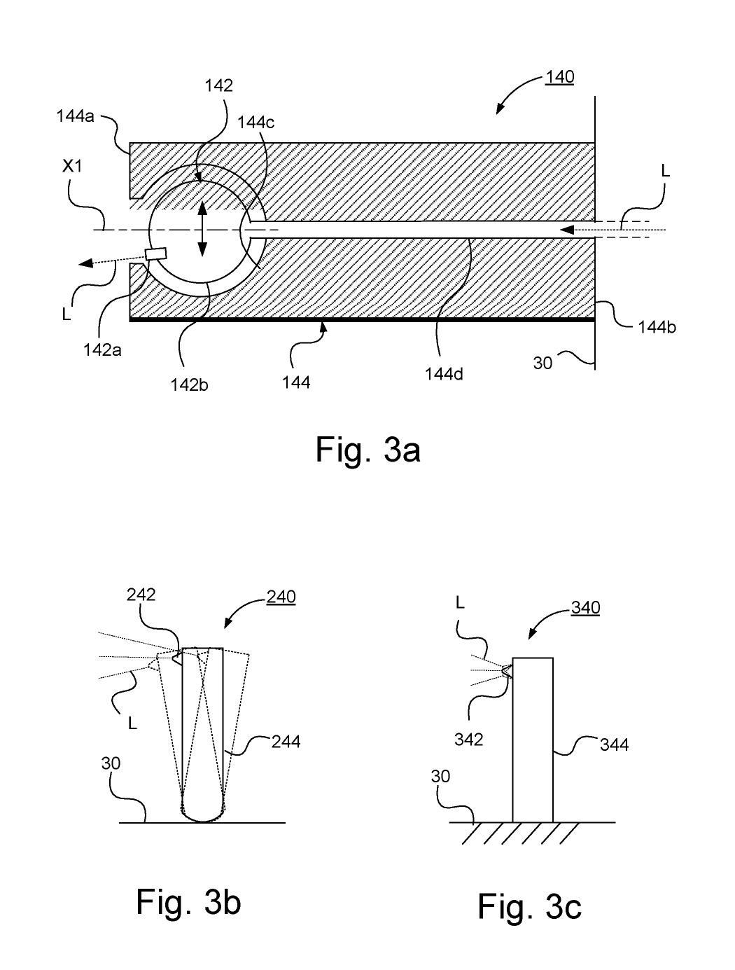

FIG. 2 schematically illustrates a cross section view of an electric motor 1 comprising a device I for liquid cooling of the electric motor according to an embodiment of the present invention, FIG. 3 schematically illustrates a side view of the electric motor comprising a device I as shown in FIG. 2.

The electric motor 1 is of inner rotor type comprising a rotor 10 and a stator 20 provided with windings. By electric motor 1 of inner rotor type is meant an electric motor 1 wherein the stator 20 is arranged to enclose the rotor 10. The exterior surface of the rotor 10 is arranged nearby and separated from the exterior surface of the stator 20. The rotor 10 is according to a variant constructed from stacked rotor plates, not shown. The rotor 10 is arranged concentrically relative to the stator 20. Hereby according to an embodiment the central axis of the rotor 10 and stator 20 substantially coincides with the central axis X of the electric motor 1. The central axis of the rotor 10 and stator 20 may according to an alternative embodiment be arranged eccentrically relative to the central axis of the electric motor 1.

Said rotor 10 is intended to be attached to a driving axle and is thus arranged to rotate the driving axle or arranged to be rotated by the driving axle. The rotor 10 comprises opposing end portions in the form of rotor ends 10a, 10b. The rotor ends 10a, 10b constitutes end surfaces of the cylinder shaped rotor 10.

The rotor 10 has an envelope surface facing the stator 20 and constitutes what is herein referred to as the exterior surface of the rotor. The electric motor 1 further comprises a rotor shaft 14 which is coupled to the rotor and extends axially from at least one rotor end 10a, 10b. The rotor shaft 14 is generally also cylinder shaped and arranged concentrically with the rotor and the stator so that its central axis coincides with the above mentioned central axis X of the electric motor 1. The rotor shaft may be a one sided rotor shaft extending from a single side of the electric motor or it may be a double sided rotor shaft extending from both sides of the electric motor such as illustrated in FIG. 2.

During operation of the electric motor 1 the rotor 10 and thereby the rotor shaft 14 is caused to rotate, whereby the rotor shaft 14 is arranged to, outside of the electric motor, transfer a driving torque to a driving means (not shown), for example for propulsion of an electrically driven motor vehicle. Alternatively the electric motor may be driven by the vehicle, wherein the electric motor brakes by means of generating a negative torque, wherein the electric motor consequently acts as a generator.

The stator 20 is according to a variant constructed from stacked stator plates (not shown). The stator 20 comprises a stator winding 22. The stator winding according to a variant comprises a set of electrically conductive wires/conductors, preferably copper wires, through which a current is arranged to be conducted for driving the electric motor 1. Said wires may be of different thickness. Said stator winding 22 is arranged to run axially so that the winding is adjacently near the rotor 10. The stator winding 22 is arranged to extend axially from end portions 20a, 20b of the stator, turned outside of the end portions 20a, 20b and reintroduced through the end portions, whereby said extending portion 22a of the stator winding forms a so called coli end 22b.

The electrically conductive wires of the stator 20 is according to a variant arranged to run axially in slots or apertures of said stator plates, whereby the different wire segments are arranged to be guided out from the end portions 20a, 20b of the stator from a slot or aperture of the stator plates and back into a different slot or aperture of the stator plates.

The stator 20 also has an envelope surface 24a. The stator 20 thereby constitutes a cylindrical housing enclosing the rotor 10 so that the envelope surface 12a of the rotor 10 is completely enclosed by an interior surface or inner surface 24b of the stator in the axial direction of the rotor. The exterior surface and also envelope surface 12 of the rotor is arranged nearby and separated from said interior surface 24b of the stator 20, whereby an air gap is formed between the rotor 10 and the stator 20.

The stator winding 22 of the stator 20 is according to the present invention arranged to run along, extend axially from and turn outside of the envelope surface of the stator 20.

The electric motor 1 further comprises a motor housing 30 enclosing the components, including the rotor 10 and the stator 20, comprised in the electric motor 1. The motor housing 30 comprises wall elements 30a 30b enclosing the rotor/stator arrangement in its axial directions, which wall elements hereinafter will be referred to as end walls 30a, 30b of the motor housing, and wall element 30c which encloses the rotor/stator arrangement in its radial directions and which hereinafter will be referred to as the envelope walls 30c of the motor housing. The motor housing may have a substantially arbitrary shape but is generally cylinder shaped whereby the envelope walls 30c of the motor housing constitutes an envelope surface in the form of a cylindrical housing enclosing the envelope surface 24a of the stator 20, and whereby the end walls 30a, 30b of the motor housing constitutes substantially circularly shaped end portions of said cylindrical housing which are arranged exteriorly and encloses the end portions of the rotor 10a, 10b and the stator 20a, 20b.

The device I for cooling comprises at least one cooling liquid applicator 40 arranged to apply cooling liquid L onto said stator 20. Said cooling liquid applicator 40 is arranged moveably relative to said stator so that the cooling liquid L by means of the movement of the cooling liquid applicator is applied onto different areas of the stator 20. The cooling liquid applicator 40 is arranged to apply cooling liquid at least onto the end portion 20a, 20b of said stator 20 and hereby the coil ends 22a, 22b of the stator winding 22.

The cooling liquid applicator 40 may be arranged and supported in any for the application suitable fashion and/or location adjacent to the stator 20 for cooling of the stator.

The cooling liquid applicator 40 is according to an embodiment arranged to be supported by said housing 30.

The device I according to FIG. 2 illustrated a number of variants of how the liquid cooling applicator may be supported.

Hereby is illustrated liquid cooling applicators 40 supported by the end portion 40 of said housing 30.

Further is shown a liquid cooling applicator 40 supported by the rotor shaft of said rotor.

Yet further is shown a liquid cooling applicator 40 supported by the envelope wall 30c of the housing 30.

Said liquid cooling applicator 40 comprises at least one nozzle 42 for application of said cooling liquid and a holder for supporting said nozzle.

The nozzle 42 is according to an embodiment arranged moveably relative to said holder 44.

According to an embodiment said nozzle 42 comprises an eccentrically arranged outlet so that the nozzle by means of a force generated by application of liquid is allowed to move relative to the holder 44. A variant of such a cooling liquid applicator is illustrated in FIG. 3a.

According to an embodiment said holder 44 is arranged moveably relative to said stator 20. According to an embodiment said holder 44 is arranged moveably relative to the attachment point, i.e., moveably arranged relative to the location where it is supported, for example the end portion 30a, 30b of the housing 30, the envelope surface of the housing 30or the rotor shaft 14, so that the cooling liquid L is distributed onto different areas of the stator 20.

Said movement of the cooling liquid applicator 40 is according to an embodiment arranged to be caused by a force generated by the application of liquid.

With reference to FIG. 2 the device I for cooling according to the present invention comprises a liquid cooling circuit comprising a pump unit 50 arranged to by means of a pump comprised in the pump unit to supply pressurized cooling liquid to the cooling liquid applicators 40 via conduits C1, C2, C3, C4.

For some embodiments the pump of the pump unit 50 is arranged to generate a substantially constant pressure of the cooling liquid L and thereby a substantially constant outflow of the cooling liquid L that is applied from the moving liquid cooling applicators 40 in directions towards the end portions 20a, 20b of the stator.

For other embodiments the device I may comprise a control unit that controls the pump of the pump unit 50 in order to adapt the outflow of cooling liquid L based on different control parameters. For example the control unit may be arranged to control the outflow of cooling liquid from the cooling liquid applicators 40 based on at least one or more control parameters comprising the number of revolutions of the electric motor and/or at least a temperature indication indicative for the temperature of the electric motor or the components comprised therein.

The control unit is according to an embodiment comprised in the pump unit 50. The control unit for controlling the pump of the pump unit 50 may be comprised of an external pump unit.

The device I is according to a variant further arranged for re-cycling of the cooling liquid that has been flushed by the cooling liquid applicators 40 onto the components of the electric motors in order to cool these components. Thereby the device I may comprise a cooling liquid tray or other gathering device for gathering of the cooling liquid having been flushed onto the components of the motor, and a cooling liquid conduit for transporting the cooling liquid L via the pump unit 50 back to the cooling liquid applicators 40 so that the cooling liquid yet again me be flushed onto the components of the electric motor.

For efficient cooling of the cooling liquid L and the components onto which it is flushed the liquid cooling device preferably comprises a cooler arranged to cool the cooling liquid L before it is re-used, i.e., after it has been gathered following having been applied to the components of the motor by the cooling liquid applicators 40 and before it has been re-introduced to the cooling liquid applicators for subsequent use by the cooling liquid applicators. The cooler is generally arranged exterior to the motor housing 30 and may for some embodiments be comprised in the pump unit 50 in order to thereby constitute a combined pump- and cooling-component which in a space conservative manner may be installed along the cooling liquid conduit. Coolers for cooling of cooling liquid are well known within the technical field and the cooler may be configured and arranged to cool the cooling liquid L according to any of the known principles for liquid cooling.

FIG. 3a-c schematically illustrates a cooling liquid applicator 140; 240; 340 according to embodiments of the present invention. The cooling liquid applicator 140; 240; 340 has been illustrated as supported by the housing 30 of the electric motor. However, the cooling liquid applicator 140; 240; 340 may be supported in any suitable fashion.

Said cooling liquid applicator 140; 240; 340 is moveably arranged relative to the stator so that the cooling liquid by means of the movement of the cooling liquid applicator is applied onto different areas of said stator. The cooling liquid applicator 140; 240; 340 is moveably arranged relative to the housing 30. The cooling liquid applicator 140; 240; 340 is moveably arranged relative to its attachment.

Said cooling liquid applicator 140; 240; 340 comprises a nozzle 142; 242; 342 for application of said cooling liquid L and a holder 144; 244; 344 for supporting said nozzle.

FIG. 3a schematically illustrates a cooling liquid applicator 140 according to an embodiment of the present invention. The cooling liquid applicators 140 comprise a nozzle 142 and a holder 144.

The nozzle 142 is moveably arranged relative to said holder 144. The nozzle 142 is spherically shaped. The nozzle 142 has a spherical body 142b. The holder 144 may have any suitable shape. The holder 144 has an outlet end 144a and a substantially opposing attachment end 144b. The nozzle 142 is arranged adjacent to the outlet end 144a, The attachment end 144b is intended to be attached adjacently to the housing 30, the rotor shaft or similar of the electric motor. The holder 144 is according to this embodiment attached onto the housing 30, for example onto the end wall portion of the housing.

The holder is arranged to comprise a space 144c arranged adjacently to the outlet end in which space the nozzle is moveably arranged. The space 144c is consequently somewhat larger than the spherical body 142c of the nozzle 142.

The holder 144 has a conduit 144d, extending from the attachment end, for transport of pressurized cooling liquid L supplied from the pump unit via the housing 30 to the nozzle 142. The nozzle 142 is coupled to the conduit 144d.

The nozzle 142 comprises an eccentrically arranged outlet 142a so that the nozzle 142 by means of a force generated by the application of liquid is allowed to move relative to the holder 144. Thereby the body 142b of the nozzle moves inside the space 144c upon supply of pressurized cooling liquid L from the conduit 144d through the nozzle 142 and its outlet 142a so that the outlet 142a by means of the generated force moves whereby the applied cooling liquid is distributed over different areas of the stator.

FIG. 3b schematically illustrates a cooling liquid applicator 240 according to an embodiment of the present invention. The cooling liquid applicator 240 comprises a nozzle 242 and a holder 244.

The holder 244 is according to this embodiment moveably arranged relative to said stator. The holder 244 is according to this embodiment moveable attached by the housing 30. Hereby the holder 244 in its entirety is allowed to move relative to the housing 30. The nozzle 242 is according to a variant fixedly attached to the holder 244. Hereby according to this embodiment the entire cooling liquid applicator 240 moves, i.e., the nozzle 242 moves jointly with the holder 244.

Upon movement of the holder 244 the cooling liquid L is hereby distributed onto different areas of the stator for provision of cooling.

FIG. 3c schematically illustrates a cooling liquid applicator according to an embodiment of the present invention. The cooling liquid applicator 340 comprises a nozzle 342 and a holder 344.

The nozzle 342 is according to this embodiment moveably arranged relative to said stator. The holder 344 is according to this embodiment fixedly attached to the housing 30. Hereby the nozzle 342 is allowed to move relative to the housing 30. The nozzle 342 is moveably attached to the holder 344. Hereby according to this embodiment the entire nozzle moves relative to the holder 344. The embodiment in FIG. 3a shows a variant of this.

Upon movement of the holder the nozzle hereby distributed the cooling liquid L onto different areas of the stator for provision of cooling.

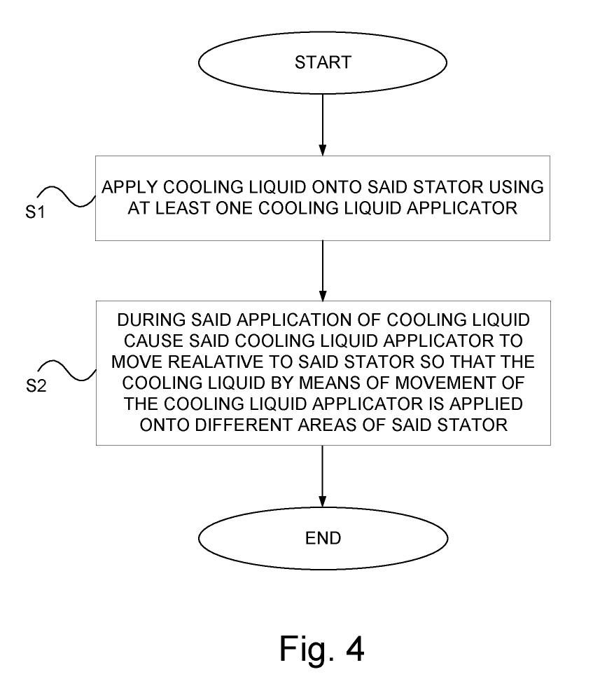

FIG. 4 schematically illustrates a flow diagram of a method for liquid cooling of an electric motor having a rotor and a stator.

According to an embodiment the method for liquid cooling of such electric motor comprises a method step S1. In this step cooling liquid is applied onto said stator by means of at least one cooling liquid applicator.

According to an embodiment the method for liquid cooling of such electric motor comprises a method step S2. In this step said cooling liquid applicator is caused to move relative to the stator, during the application of the cooling liquid L, so that the cooling liquid by means of the movement of the cooling liquid applicator is applied onto different areas of said stator.

According to an embodiment the method step of applying said cooling liquid comprises applying cooling liquid by means of a nozzle supported by a holder for said nozzle.

According to an embodiment the method comprises step of applying cooling liquid for causing of movement of the nozzle relative to said holder.

According to an embodiment the method step of applying said cooling liquid takes place using an eccentrically arranged outlet of the nozzle so that the nozzle is allowed to move relative to the holder by means of a force generated by the application of liquid.

According to an embodiment the method comprises the step of causing said holder to move relative to the stator during the application of cooling liquid L.

According to an embodiment the method comprises the step of generating a force generated by the application of cooling liquid for causing of said movement of the cooling liquid applicator.

According to an embodiment the method the step of applying cooling liquid onto said stator comprises to apply cooling liquid at least onto an end portion of said stator.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications suited to the particular use contemplated.

1. A device for liquid cooling an electric motor having a rotor and a stator, comprising:
a cooling liquid applicator arranged to apply cooling liquid onto said stator, wherein said liquid cooling applicator is moveably arranged relative to said stator so that the cooling liquid based on movement of the cooling liquid applicator is applied onto different areas of said stator, said cooling liquid applicator comprises a nozzle for application of said cooling liquid and a holder for supporting said nozzle, and said nozzle is moveably arranged relative to said holder.

2. The device according to claim 1, wherein said nozzle comprises an eccentrically arranged outlet so that the nozzle is allowed to move relative to the holder due to a force generated by the application of liquid.

3. The device according to claim 1, wherein said holder is moveably arranged relative to said stator.

4. The device according to claim 1, wherein said movement of the cooling liquid applicator is arranged to be caused by a force generated by the application of liquid.

5. The device according to claim 1, wherein said cooling liquid applicator is supported by a housing encompassing the electric motor.

6. The device according to claim 5, wherein the cooling liquid applicator is supported by an end wall portion of said housing.

7. The device according to claim 1, wherein the cooling liquid applicator is supported by a rotor shaft of said rotor.

8. The device according to claim 1, wherein the cooling liquid applicator is arranged to apply the cooling liquid at least onto an end portion of said stator.

9. A method for liquid cooling an electric motor having a rotor and a stator, comprising the steps of:
applying cooling liquid onto said stator using at least one cooling liquid applicator,
during said application of cooling liquid causing said cooling liquid applicator to move relative to said stator so that the cooling liquid of based on movement of the cooling liquid applicator is applied onto different areas of said stator,
wherein the step of applying cooling liquid comprises applying cooling liquid using a nozzle supported by a holder for said nozzle, for causing of movement of the nozzle relative to said holder.

10. The method according to claim 9, wherein the step of applying cooling liquid is performed using an eccentrically arranged outlet of the nozzle so that the nozzle is allowed to move relative to the holder due to a force generated by the application of liquid.

11. The method according to claim 9, comprising the step of causing said holder to move relative to the stator during said application of cooling liquid.

12. The method according to claim 9, comprising the step of generating a force by the application of liquid in order to cause said movement of the cooling liquid applicator.

13. The method according to claim 9, wherein the step of applying cooling liquid onto said stator comprises applying cooling liquid to at least one an end portion of said stator.

14. A platform comprising the device according claim 1.

15. The platform according to claim 14, comprising a vehicle.
